(19) United States
(12) Patent Application Publication
(10) Pub. No.: US 2013/0166145 A1
(43) Pub. Date: Jun. 27, 2013

(54) CAR WITH CONTROLLING SYSTEM

(71) Applicant: PO-CHOU CHEN, Tu-Cheng (TW)

(72) Inventor: PO-CHOU CHEN, Tu-Cheng (TW)

(21) Appl. No.: 13/658,084

(22) Filed: Oct. 23, 2012

(30) Foreign Application Priority Data
Dec. 26, 2011 (TW) 100148723

(51) Int. Cl. G06F 17/00

(52) U.S. Cl. 701/36

(57) ABSTRACT

A car includes a steering wheel, a controlling system, and a plurality of buttons. The controlling system includes a controlling module, a plurality of signal detecting modules, and a display screen. The display screen is within easy viewing range of the driver. The plurality of buttons are mounted on the steering wheel. The controlling module controls the plurality of signal detecting modules to present different signals to the display screen. The display screen then displays the signals from the signal detecting modules. The controlling module controls the display of different signals on the display screen responding to the operation of page-forward and previous-page buttons.

### BACKGROUND

1. Technical Field

The present disclosure relates to cars, particularly to a car including a controlling system.

2. Description of Related Art

Cars are typically equipped with basic equipments, such as, a temperature indicator, and an oil indicator, for example. In addition, cars may be equipped with plenty of functional modules for achieving different functions, such as satellite navigation, rear-mounted camera and real-time video for backing up or driving in reverse, driving speed detecting module, for example. Each of the satellite navigation and backing up real-time video has a display screen to present information to a driver. However, it is dangerous for the driver or operator to watch too many display screens when driving the car.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a partial, isometric view of an embodiment of a dashboard of a car.

FIG. 2 is a block schematic view of the car shown in FIG. 1.

### DETAILED DESCRIPTION

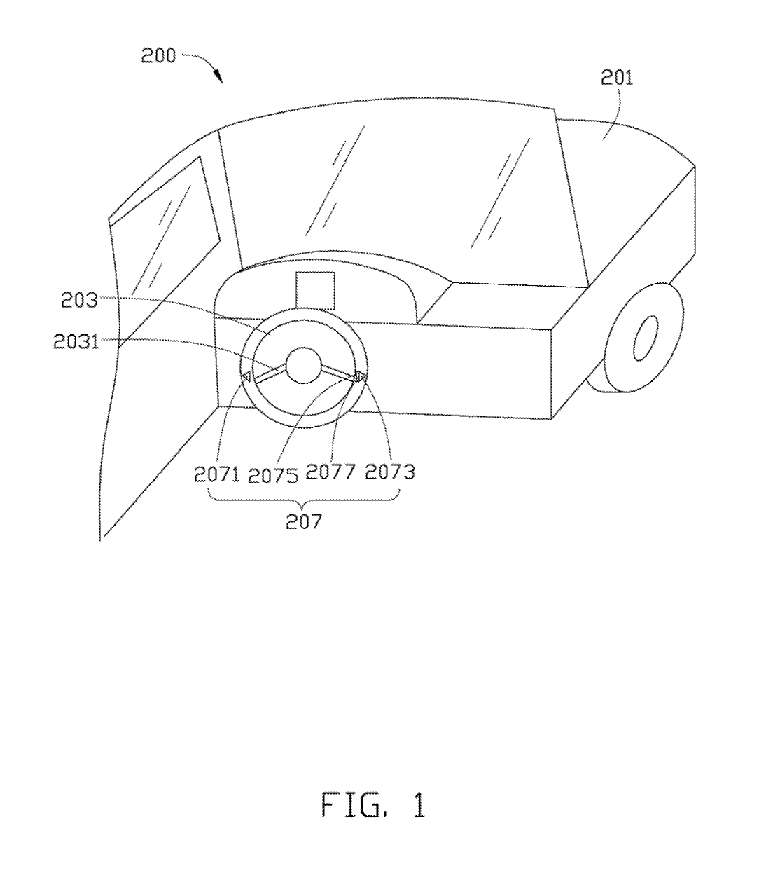

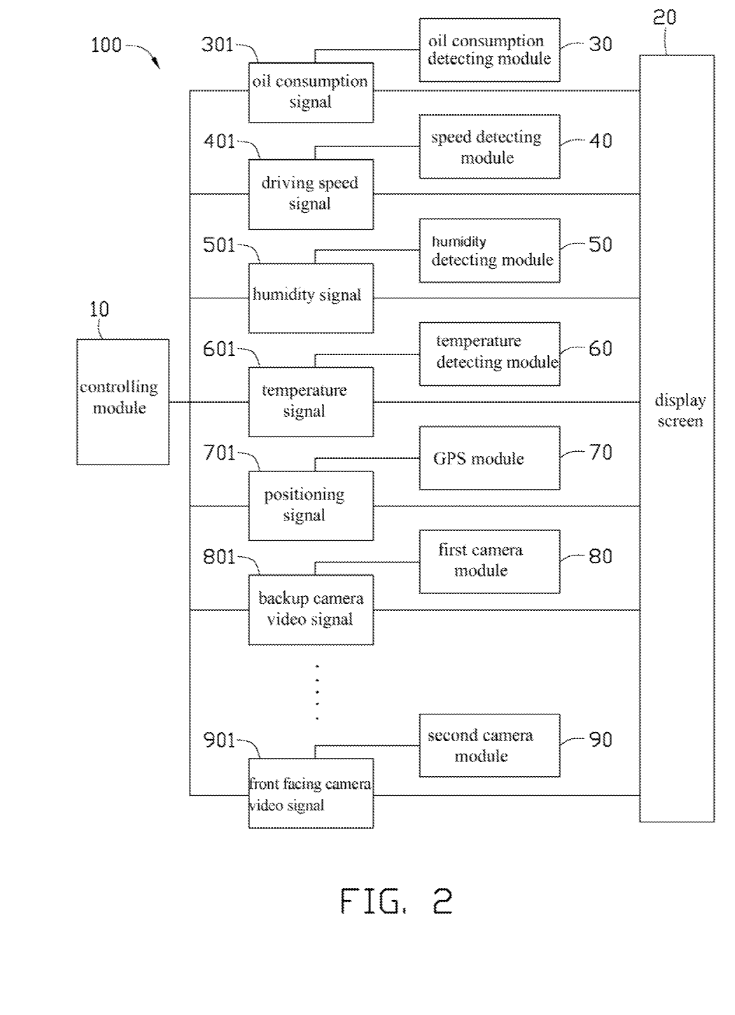

Referring to FIGS. 1 and 2, an embodiment of a car 200 is shown. The car 200 includes a main body 201, a steering wheel 203, a plurality of buttons 207, and a controlling system 100 received in the main body 201. The steering wheel 203 is mounted on the main body 201. The buttons 207 are mounted on the steering wheel 203. In the illustrated embodiment, the buttons 207 are located at a position on the steering wheel 203 which enables the operator to press the buttons 207 conveniently with fingers or thumbs. In other embodiments, the buttons 207 can be located at other places in the car 200 to allow for pressing convenience by the operator, such as to be located on the steering wheel spoke (refer to a connecting rod 2031 of the steering wheel 203) for example. The buttons 207 can be touch buttons.

The controlling system 100 includes a controlling module 10, a plurality of signal detecting modules, and a display screen 20. The display screen 20 is mounted on the main body 201 in front of the steering wheel 203. In the illustrated embodiment, the plurality of signal detecting modules include an oil consumption detecting module 30, a speed detecting module 40, a humidity detecting module 50, a temperature detecting module 60, a Global Positioning System (GPS) module 70, a first camera module 80, and a second camera module 90. In other embodiments, the plurality of signal detecting modules can include other types of modules for detecting other signals, such as modules for detecting road conditions, and weather conditions, for example. The display screen 20 can be set at other places in the car 200 visible to the operator.

The controlling module 10 is received within the steering wheel 203, and controls the plurality of signal detecting modules. The plurality of signal detecting modules are received within the main body 201. The oil consumption detecting module 30 is configured to detect an oil consumption signal 301 of the car 200. The speed detecting module 40 is configured to detect a driving speed signal 401 of the car 200. The humidity detecting module 50 is configured to detect a humidity signal 501 of the car 200. The temperature detecting module 60 is configured to detect a temperature signal 601 of the car 200. The GPS module 70 is configured to detect a positioning signal 701 of the car 200. The first camera module 80 is mounted on a rear-end of the main body 201, and is configured to receive images of the scene viewed behind the car when driving in reverse (backup camera video signal 801). The second camera module 90 is mounted on a front end of the main body 201, and is configured to detect a front facing camera video signal 901. In other illustrated embodiments, the controlling module 10 can be received within the main body 201.

In the illustrated embodiment, the buttons 207 includes a page up button 2071 for changing to a previous-page, a next-page button 2073, an image enlargement button 2075, and an image-reduction button 2077. The previous-page button 2071 is positioned on a grasping position (8 o'clock position) of the steering wheel 203 at the left side of the steering wheel 203 for the operator's left hand to grasp, and the next-page button 2073 is positioned on another grasping position (4 o'clock position) of the steering wheel 203 at the right side of the steering wheel 203 for the operator's right hand to grasp. The image enlargement button 2075 and the image reduction button 2077 are located besides the next-page button 2073. The control module 10 controls the signal detecting modules to input various signals to be displayed on the display screen 20, and controls the display of different signals on the display screen 20 in response to the operation of the previous-page button 2071 and the next-page button 2073. For example, the display screen 20 may present a temperature signal 601 from the temperature detecting module 60, and when the previous-page button 2071 is depressed, the display screen 20 is controlled to display one humidity signal 501 inputted by the humidity detecting module 50, and when the page-up button 2073 is depressed, the current image as viewed on the display screen 20 is changed to display a positioning signal 701 inputted by the GPS module 70.

The image enlargement button 2075 and the image reduction button 2077 are configured to adjust the size of the image displayed on the display screen 20. In particular, when the display screen 20 displays the positioning signal 701 from the GPS module 70, the image on the display screen 20 can be adjusted to a larger size or a smaller size simply by operation of the image enlargement button 2075 and the image reduction button 2077, and can be moved to left or right by operation of the previous-page button 2071 and the next-page button 2073, for allowing the operator easy access to displayed information.

In other embodiments, the buttons 207 can includes other functional buttons, such as a menu button (not shown) for allowing the controlling module 10 to automatically define a display order, for example. The previous-page button 2071, the next-page button 2073, the image enlargement button 2075, and the image reduction button 2077 can be positioned at another location that is convenient to operate by the driver or operator, such as, for example, being positioned near the grasping position on the steering wheel 203. The controlling module 10 can control to send more than one signal to be presented on the display screen 20 at a same time for rapid and efficient viewing of displayed information, such as having a left side of the display screen 20 displaying a humidity signal 501 and a right side of the display screen 20 displaying a temperature signal 601. In alternative embodiment, more than one display screen 20 can be configured for presenting multiple displayed information resulting from different signals at the same time.

Because the buttons 207 are set or configured on the steering wheel 203, the operator can operate the buttons 207 conveniently when operating the steering wheel 203, and may operate the buttons 207 by feel alone without requiring to look and see the buttons 207, and this ensures better safety when driving. A plurality of signals can be cycled through on the display screen 20 via pressing the previous-page button 2071 and the next-page button 2073, without the driver having to move his head to search for different information across the dashboard. This makes it convenient for drivers to obtain information.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A car, comprising:
a steering wheel,
a controlling system comprising a controlling module, a plurality of signal detecting modules, and a display screen, the display screen positioned near the steering wheel; and
a plurality of buttons mounted on the steering wheel,
wherein the controlling module controls the plurality of signal detecting modules to detect a plurality of different signals, the display screen displays the plurality of signals from the signal detecting modules, the controlling module controls the plurality of different signals switched to be displayed on the display screen responding to the operation of the plurality of buttons.

2. The car of claim 1, wherein the plurality of signal detecting modules include a speed detecting module, a temperature detecting module, a GPS module, a first camera module, and a second camera module, for detecting a driving speed signal, a temperature signal, a positioning signal, a backup camera video signal, and a front facing camera video signal, respectively.

3. The car of claim 2, wherein the first camera module is mounted on a rear-end of the car, the second camera module is mounted on a front end of the car.

4. The car of claim 1, wherein the buttons includes a previous-page button, a next-page button, an image enlargement button, and an image reduction button, the controlling module controls the display of different signals switched on the display screen responding to the operation of the previous-page button and the next-page button, the controlling module controls the size of image displayed on the display screen responding to the operation of the image enlargement button and the image reduction button.

5. The car of claim 4, wherein the controlling module controls an image on the display screen to be a larger size or a smaller size responding to the operation of the image enlargement button and the image reduction button.

6. The car of claim 4, wherein the previous-page button is located on a grasping position of the steering wheel at the left side of the steering wheel for an operator's left hand to be grasping, the next-page button is located at on a grasping position of the steering wheel at the right side of the steering wheel for the operator's right hand to be grasping.

7. The car of claim 4, wherein the previous-page button is located near a grasping position of the steering wheel at the left side of the steering wheel for an operator's left hand to be grasping, the next-page button is locate near a grasping position of the steering wheel at the right side of the steering wheel for the operator's right hand to be grasping.

8. The car of claim 1, wherein the buttons are located at a grasping position of the steering wheel for an operator's hand to be grasping.

9. A car, comprising:
a steering wheel,
a controlling system comprising a controlling module,
a plurality of signal detecting modules,
a display screen, the display screen positioned near the steering wheel; and
a plurality of buttons mounted on the steering wheel, comprising a menu button, a previous-page button and a next-page button,
wherein the controlling module controls the plurality of signal detecting modules to detect a plurality of different signals, the display screen displays the plurality of different signals detected by the signal detecting modules, the controlling module automatically defines a display order responding to the operation of the menu button, and controls the plurality of different signals switched to be displayed on the display screen responding to the operation of the previous-page button and the next-page button.

10. The car of claim 9, wherein the plurality of signal detecting modules include a speed detecting module, a temperature detecting module, a GPS module, a first camera module, and a second camera module, for detecting a driving speed signal, a temperature signal, a positioning signal, a backup camera video signal, and a front facing camera video signal, respectively.

11. The car of claim 10, wherein the first camera module is mounted on a rear-end of the car, the second camera module is mounted on a front end of the car.

12. The car of claim 9, wherein the buttons further includes an image enlargement button, and an image reduction button, the controlling module controls the size of image displayed on the display screen responding to the operation of the image enlargement button and the image reduction button.

13. The car of claim 12, wherein the controlling module controls the image on the display screen to be a larger size or a smaller size responding to the operation of the image enlargement button and the image reduction button.

14. The car of claim 9, wherein the previous-page button is located at a grasping position of the steering wheel at the left side of the steering wheel for grasping by an operator's left hand, the next-page button is located at a grasping position of the steering wheel at the right side of the steering wheel for grasping by the operator's right hand, the image enlargement button and the image reduction button are located besides the next-page button.

15. The car of claim 9, wherein the previous-page button is located near a grasping position of the steering wheel at the left side of the steering wheel for grasping by an operator's left hand, the next-page button is located near a grasping position of the steering wheel at the right side for grasping by the operator's right hand.
